(19) United States
(12) Patent Application Publication
(10) Pub. No.: US 2005/0094866 A1
(43) Pub. Date: May 5, 2005

(54) Position reference beacon for integrated circuits

(76) Inventors: Ruben W. Castelino, Marlborough, MA (US); John A. Kowaleski JR., Princeton, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,183

(22) Filed: Nov. 3, 2003

(51) Int. Cl. G06K 9/00

(52) U.S. Cl. 382/149; 382/145

(57) ABSTRACT

A beacon for providing a reference location on an integrated circuit is disclosed. The beacon comprises a device capable of emitting radiation and disposed at a corresponding reference location on the integrated circuit, wherein the device is capable of being controlled independent of integrated circuit operations.

### BACKGROUND

1. Field of the Invention

The present invention relates generally to integrated circuits and, more particularly, to a position reference beacon for an integrated circuit.

2. Related Art

Modern design and manufacturing processes enable manufacturers to produce a great variety of integrated circuits (ICs). ICs are commonly used in computers, mobile telephones, automobiles and many other products. Some ICs contain digital circuits such as flip-flops, inverters and other logic circuits that can switch between binary states at speeds exceeding 10 GHz. Most logic circuits include at least one transistor which switches between an on and off state to reflect the binary state of the circuit or a portion thereof. Some modern ICs, such as microprocessors, include millions of transistors on a single IC die.

One or a small number of failed or unreliable transistors or other components in an IC can render the IC inoperable. Therefore, manufacturers of ICs, and manufacturers of products that include ICs, often perform a number of tests on their ICs. Such testing can involve, for example, providing predetermined input signals to the ICs and observing resulting changes in the states of logic circuits in the ICs.

Several techniques have been developed to observe state changes in an IC. For example, a field-effect transistors (FET) in complementary metal-oxide silicon (CMOS) logic circuits can emit small amounts of light, typically only a few photons, when the FET changes state. Sensitive test equipment, such as time-resolved emission microscopy systems, can detect such light emissions, even through an IC's encapsulating material or through the back side (substrate) of the IC. Such test equipment can accumulate detected light emissions and produce motion pictures depicting state changes in the FETs of an IC. For example, in one such system commonly referred to as a Picosecond Imaging Circuit Analysis (PICA) system, the detected photons are presented as flashes of light in a PICA image window to represent component state changes. Because a flash typically lasts less than 100 picoseconds, the motion pictures are typically played back at reduced speed to facilitate human observation and analysis.

If the circuits that produce the flashes can be identified, the flashes can be used to follow signals as they pass from circuit to circuit in an IC to determine whether the circuits are operational. Traditionally, to facilitate correlating the light flashes with the circuits that generate them, images of the light flashes have been superimposed on a photomicrograph or a computer-aided design/manufacturing (CAD/M) diagram of the IC, which show the relative locations of the circuits on the IC die. Unfortunately, registering a PICA image window with a photomicrograph or CAD/M diagram is difficult because it involves a tedious trial-and-error method of selecting and then locating circuits on an IC.

In some conventional diagnostic methodologies, light flashes are analyzed without superimposing them on a photomicrograph or CAD/M diagram. In these situations, identifying the circuits that produce the light flashes can be particularly difficult. Similarly, if a user is uncertain whether a circuit that is being tested is functional, it is difficult to determine where in a PICA image window to look for flashes that would be produced by that circuit. Thus, conventional methods of determining locations of circuits in a PICA image window are time consuming and error prone.

### SUMMARY OF THE INVENTION

In one aspect of the present invention, a position reference beacon for an integrated circuit is disclosed. The beacon comprises a device capable of emitting radiation and disposed at a reference location on the integrated circuit, wherein the device is capable of being controlled independent of integrated circuit operations.

In another aspect of the present invention, a method for identifying a location of interest on an integrated circuit is disclosed. The method comprises providing at least one beacon capable of emitting radiation, positioned at a corresponding reference location on the integrated circuit and capable of being controlled independent of the normal operation of the integrated circuit.

In yet a further aspect of the present invention, an integrated circuit is disclosed. The integrated circuit comprises: at least one beacon circuit, each having at least one component capable of emitting radiation and being disabled without impacting normal operation of the integrated circuit; and functional circuitry located on the integrated circuit at a predetermined location relative to the at least one beacon circuit.

### BRIEF DESCRIPTION OF THE DRAWINGS

FIG. 1A is a diagram of a portion of an exemplary IC die, in which embodiments of the present invention can be practiced.

FIG. 1B is a diagram of a the IC die illustrated in FIG. 1A with a reference frame overlaid on the IC die, in which embodiments of the present invention can be practiced.

FIG. 2A is a cross-sectional diagram of a field-effect transistor, such as one that might be found in a circuit on an IC, such as the one depicted in FIGS. 1A and 1B.

FIG. 2B is an enlarged view of a portion of the IC shown in FIG. 2A.

FIG. 3 is an schematic wiring diagram of one embodiment of a beacon circuit that exploits the photons emitted by devices, such as MOSFETs, which experience hot carrier events.

FIG. 4 is an idealized graph of operating voltages for a metal-oxide semiconductor field-effect transistor (MOSFET) showing exemplary conditions under which the MOSFET is likely to experience hot carrier events.

FIG. 5 is a timing diagram produced by a simulation of the beacon circuit illustrated in FIG. 3 when the beacon circuit is operational.

FIG. 6 is a timing diagram produced by a simulation of the beacon circuit illustrated in FIG. 3 when the beacon circuit is disabled.

FIG. 7 is a simplified block diagram of a beacon system, such as one that can be implemented on the IC die of FIG. 1, according to an embodiment of the present invention.

FIG. 8 is an exemplary flowchart illustrating operation of an embodiment of the present invention.

FIG. 9 is an exemplary flowchart illustrating operation of another embodiment of the present invention.

### DETAILED DESCRIPTION

Embodiments of the present invention are directed to establishing and/or using one or more position reference beacons at predetermined locations on an integrated circuit (IC) to identify circuits, features or other locations of interest on the IC, and/or to provide coordinates of such locations of interest. When the IC is tested, at least one selected beacon is activated. Emissions from the activated beacon(s) can be detected by appropriate diagnostic equipment now or later developed. Once established, the physical location reference points on the IC that are associated with the detected beacon(s) can be used in several ways.

In one embodiment described in detail below, locations of interest are determined relative to the positions of the beacons. This determination can be based on, for example, computer-aided design/manufacturing (CAD/M) information that often includes coordinates of the beacons and coordinates of, or distances to, the locations of interest on the IC.

In another embodiment, beacon emissions can also be used to establish a frame of reference from which circuits, features or other locations of interest on the die can be located. For example, a reference frame can be used to identify circuits that produce flashes in a PICA image window. Alternatively, a reference frame can be used to determine where in a PICA image window to look for flashes emitted by a circuit of interest. Using conventional diagnostic systems, it is difficult to interpret light flashes, or lack thereof, seen in a PICA image window, because no reliable information is available to correlate points in the PICA image window with circuits on a die. In contrast, embodiments of the present invention provide physical location reference points on an IC, which can be used to correlate observations in a PICA window with circuits or other locations on the IC.

Alternatively or in addition to the above uses, detected emissions from the position reference beacons can also be used to register a PICA image window with a photomicrograph or CAD/M diagram of an IC die or portion thereof. Because the locations of the beacons on the photomicrograph and CAD/M diagram are known, the locations of the beacons on the photomicrograph or CAD/M drawing can be aligned with the detected beacons.

In contrast, conventional systems typically require a user to conduct a series of experiments to correlate portions of a PICA image window with portions of the IC die. Typically, the user programs a test instrument to send predetermined signals to an IC under test, thereby causing selected circuits within the IC to change states in predetermined patterns. The user then searches for light flash patterns that are consistent with the expected state changes of the selected circuits.

Unfortunately, it is often difficult to select appropriate circuits on an IC that can be used for the registration experiments. Furthermore, sometimes the circuits selected for the registration experiment have failed or are unreliable and, therefore, do not behave as anticipated. As a result, this and other conventional methods of registering a PICA image with a photomicrograph or CAD/M drawing, or of determining locations of circuits that are to be tested in a PICA image window, are time consuming and error prone.

In contrast, embodiments of the present invention provide dedicated beacons at predetermined locations to facilitate registering photomicrographs or CAD/M drawings with PICA image widows. In one embodiment of the present invention, the beacons are implemented as circuits (“beacon circuits”) on the IC. When enabled, the beacon circuits are controlled so that at least one device of the circuit is likely to experience hot carrier events and, therefore, emit flashes of light. Hot carrier events are described in more detail below. Conventional design methodologies strive to avoid hot carrier events, due to circuit degradation caused by such events. In contrast, embodiments of the present invention intentionally operate dedicated circuits under conditions that are likely to cause hot carrier events. Although the useful life of such a circuit might, therefore, be reduced, it is sufficiently long to establish a reference frame, register a PICA image window or perform other diagnostic or test operations.

In addition, in some embodiments the brilliance of the light emitted by the circuit device when it experiences hot carrier events, or the operational lifetimes of such a device under controlled conditions, can be used to calibrate test instruments or provide other useful information about an IC. For example, operating the beacon circuit continuously until the device fails can facilitate estimating the useful life of the IC.

Furthermore, the beacon circuits are typically not involved in normal operation of the IC; that is, they are usually disabled when the IC is in normal use, and are preferably enabled only for diagnostic purposes. Therefore, even if some or all of the beacon circuits fail after some amount of diagnostic testing, the remainder of the IC is not impacted, and the IC can enter or return to normal service. Furthermore, the beacon circuits can be ignored by a system, such as a personal computer, that includes the IC, but that does not conduct IC tests that require positional information about portions of the IC.

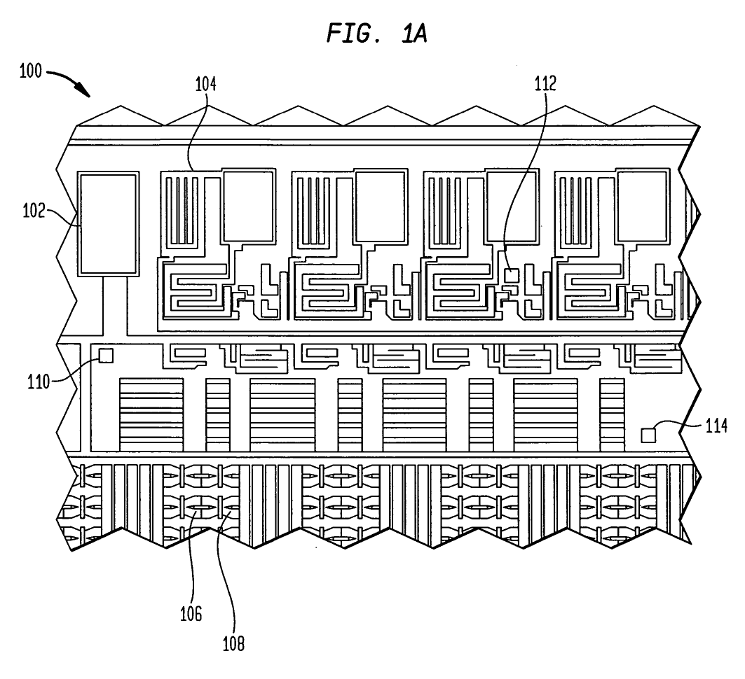

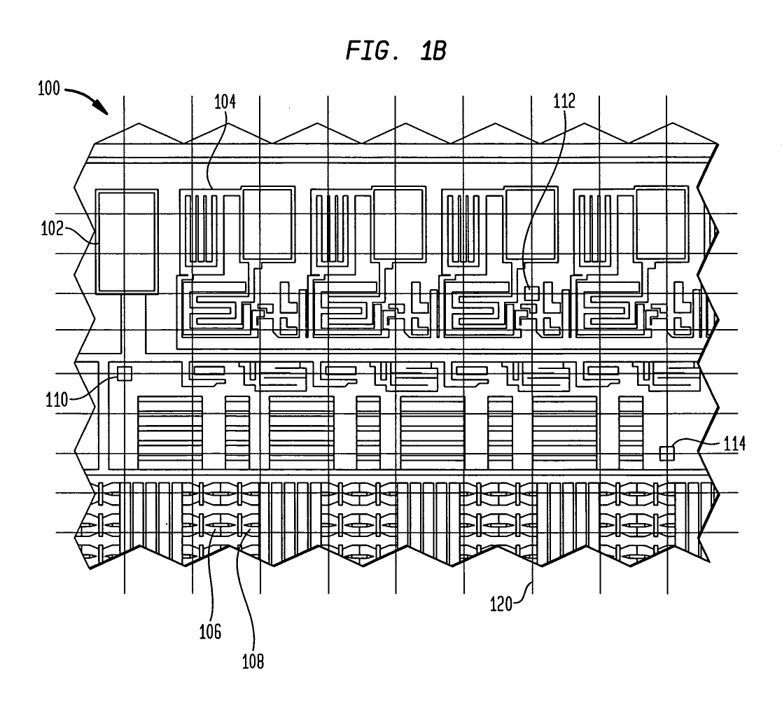

FIG. 1A is a diagram of a portion of an exemplary IC die 100, in which embodiments of the present invention can be practiced. Exemplary features 102, 104, 106 and 108 are circuits or other locations of potential interest on die 100. For example, features 102-108 can be individual components, such as field-effect transistors (FETs) or coils; digital circuits, such as flip-flops or inverters; or analog circuits, such as amplifiers or oscillators. In accordance with embodiments of the present invention, exemplary position reference beacons 110, 112 and 114 (collectively and generally referred to as beacons 110) can be used to establish corresponding physical location reference points and/or a reference frame, as described in detail below. For example, once having established the location of at least one beacon 110, a user can establish a frame of reference, such as grid 120 illustrated in FIG. 11B. Grid 120 enables the user or an automated tester to locate or identify circuits and other locations of interest on IC die 100.

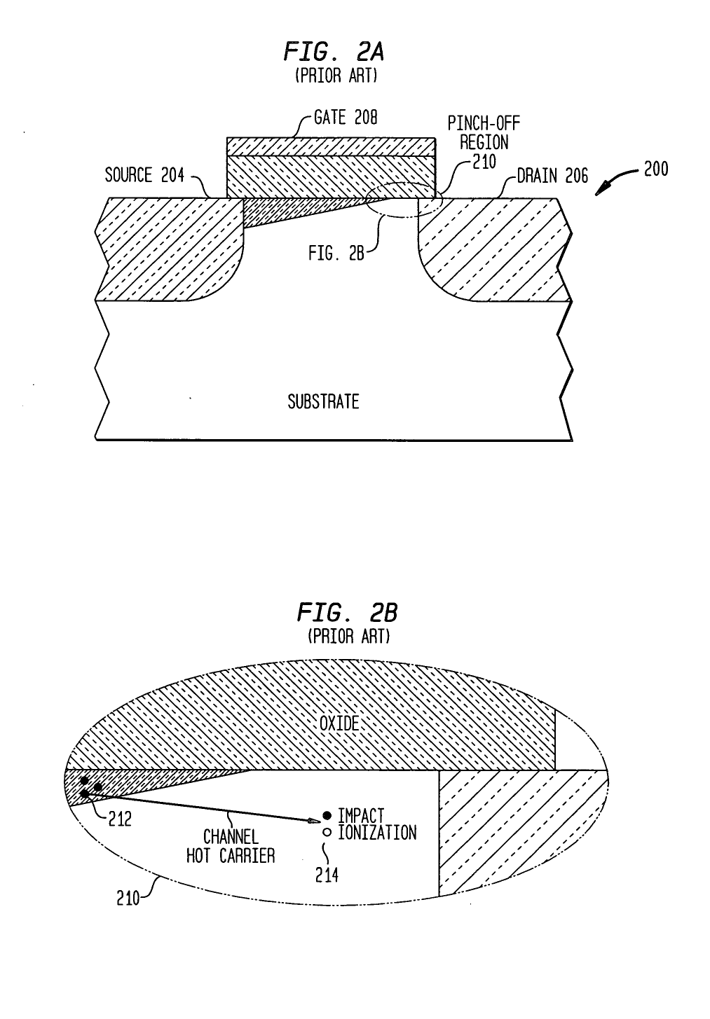

In one embodiment, each beacon 110 includes a component or circuit that can be operated such that it is likely to produce light. For example, a metal-oxide semiconductor field-effect transistor (MOSFET) operated at sufficiently high voltages can experience hot carrier events. As is well known in the art, hot carrier events cause the release of photons; that is, they produce detectable flashes of light. FIG. 2A is a cross-sectional diagram of an n-channel MOSFET 200 operating in saturation to show how such a MOSFET can experience hot carrier events. MOSFET 200 has a source 204, a drain 206 and a gate 208. The voltage across source 204 and drain 206 is commonly known as V_{DS}, and the voltage across gate 208 and source 204 is commonly known as V_{GS}.

FIG. 2B is an enlarged view of a portion of MOSFET 200, referred to as a pinch-off region 210. Operating with a large voltage drop across pinch-off region 210 between drain 206 and source 204 (V_{DS}) results in a high lateral electric field close to drain region 206. Carriers 212 traversing this high electric field region reach energies considerably higher than the equilibrium thermal energy in the semiconductor lattice. Such high-energy carriers, commonly referred to as “hot carriers,” collide with impurities in the substrate, splitting into electron-hole pairs 214, in a process referred to as impact ionization. The electron-hole pairs 214 recombine to release radiation (commonly referred to as recombination radiation), typically in the form of photons. This process of splitting and recombining can be caused by hot carrier events.

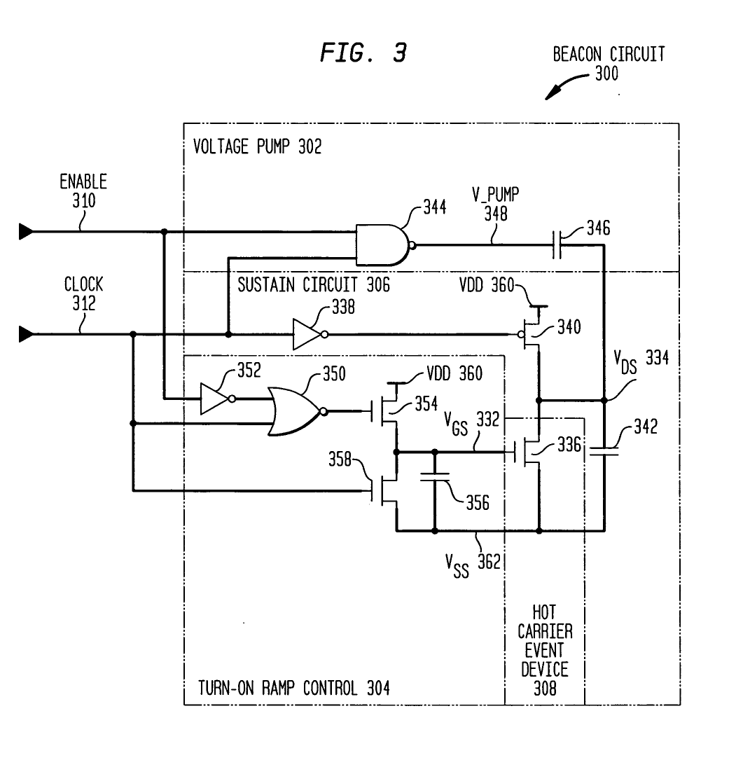

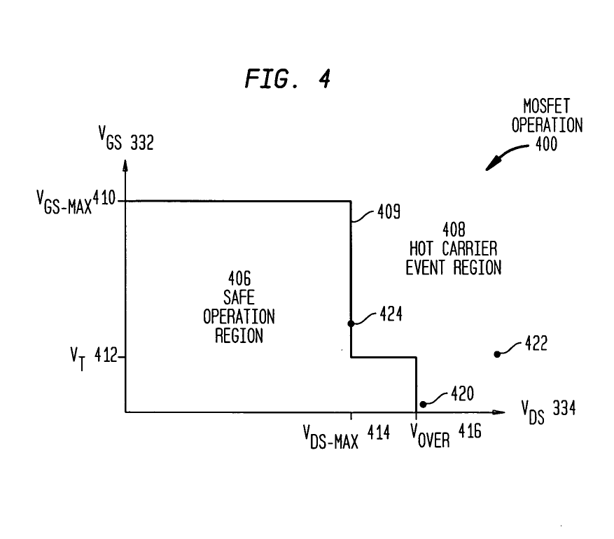

FIG. 3 is a circuit diagram of an exemplary beacon circuit 300, according to one embodiment of the present invention. This embodiment exploits the emission of photons by devices, such as MOSFETs, that can experience hot carrier events. Beacon circuit 300 places a device 308 into a condition in which the device is likely to experience hot carrier events, and preferably maintains that condition for an extended period of time to facilitate detection of the recombination radiation. In this exemplary embodiment, device 308 is a MOSFET 336. As such, in this example, beacon circuit 300 applies sufficiently high voltages V_{DS} and V_{GS} to MOSFET 336 to create and maintain conditions that increase the likelihood that the MOSFET experiences hot carrier events.

It should be appreciated that hot carrier events, and the attendant light emissions, are probabilistic events. That is, although it is possible to establish conditions under which hot carrier events are likely to occur, it is not possible to ensure the occurrence of such events. For simplicity, reference will be made herein to generating light flashes, rather than to increasing the likelihood of generating hot carrier events.

FIG. 4 is an idealized graph of operating voltages V_{GS} 332 and V_{DS} 334 for MOSFET 336, showing exemplary conditions under which the MOSFET is likely to experience hot carrier events. The vertical axis represents V_{GS} 332 while the horizontal axis represents V_{DS} 334. V_{GS} 332 and V_{DS} 334 can, of course, be independently controlled. Therefore, every point in graph 400 represents a combination of V_{GS} 332 and V_{DS} 334 that could be applied to MOSFET 336.

Two operating regions are identified in graph 400. The first region is safe operating region 406 in which MOSFET 336 performs under normal operating conditions and, therefore, is not likely to experience hot carrier events. Conventionally, MOSFETs operate in safe operating region 406. The second region, referred to as hot carrier event region 408, represents the combinations of V_{GS} 332 and V_{DS} 334 that increase the likelihood that MOSFET 336 experiences hot carrier events.

A boundary 409 separates regions 406 and 408. Values for V_{GS} 332, namely, V_{GS-MAX} 410 and V_{T} 412, and values for V_{DS}, namely V_{OVER} 416 and V_{DS-MAX} 414, are shown along the respective vertical and horizontal axes to identify points at which boundary 409 changes direction or intersects one of the axes. As is well known in the art, a MOSFET has a characteristic V_{MAX} value, which is typically process-specific. However, for clarity, this voltage is referred to herein as V_{GS-MAX} 410 when it is used as a threshold valve for V_{GS} 332, and as V_{DS-MAX} 414 when it is used as a threshold valve for V_{DS} 334. As one of ordinary skill in the art would find apparent, each MOSFET has its own characteristic values of V_{GS-MAX} 410, V_{T} 412, V_{DS-MAX} 414 and V_{OVER} 416; accordingly, to avoid confusion, specific voltage values are not called out in FIG. 4. V_{GS-MAX} 410 and V_{DS-MAX} 414 are typically approximately equal to V_{DD} 360 (FIG. 3).

As is also well known in the art, V_{T} 412 is the value that V_{GS} 332 must at least be before MOSFET 336 begins to turn on, and V_{GS-MAX} 410 is the value that V_{GS} 332 must at least be for MOSFET 336 to be fully on. Note that while V_{GS} 332 is less than V_{T} 412, V_{DS} 334 can exceed V_{DS-MAX} 414 without entering hot carrier event region 408, as long as V_{DS} 334 does not exceed V_{OVER} 416. However, once V_{GS} 332 exceeds V_{T} 412, V_{DS} 334 should remain below V_{DS-MAX} 414 to remain within safe operation region 406. As described in detail below, beacon circuit 300 selectively controls operating voltages V_{GS} 332 and V_{DS} 334 for MOSFET 336 to cause the MOSFET to operate within hot carrier event region 408.

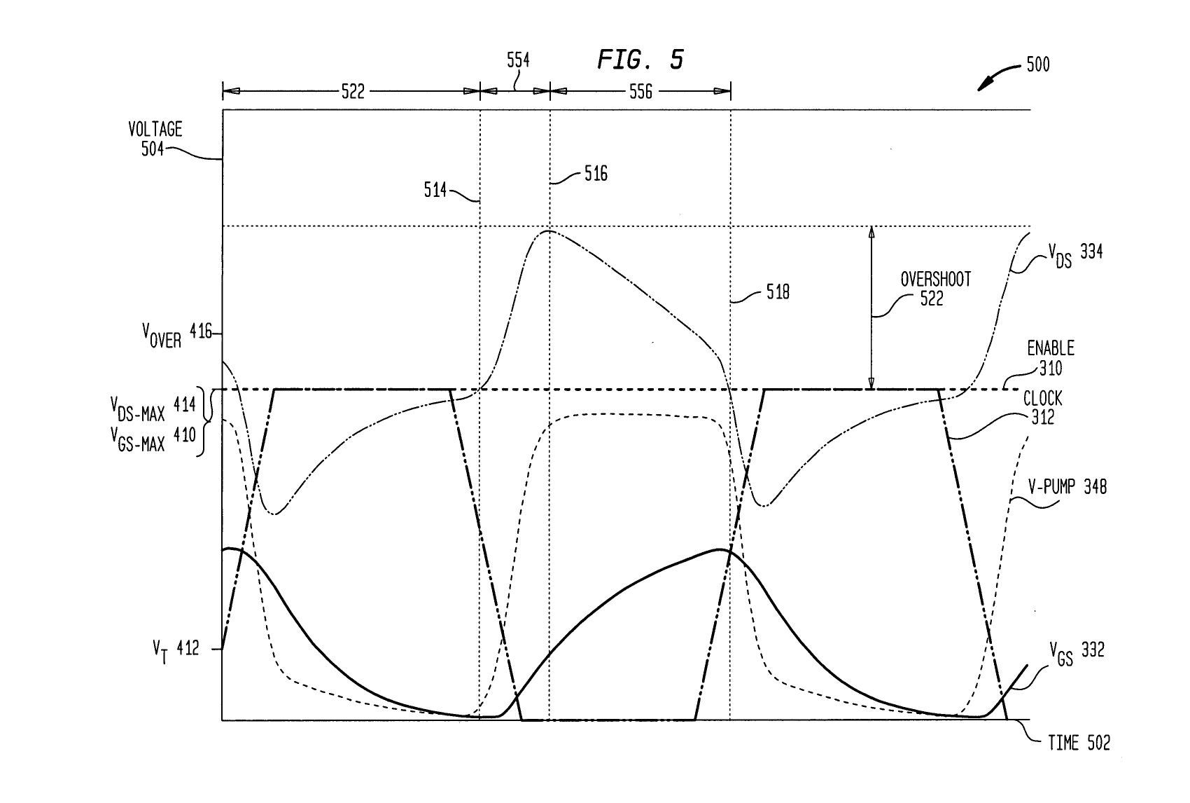

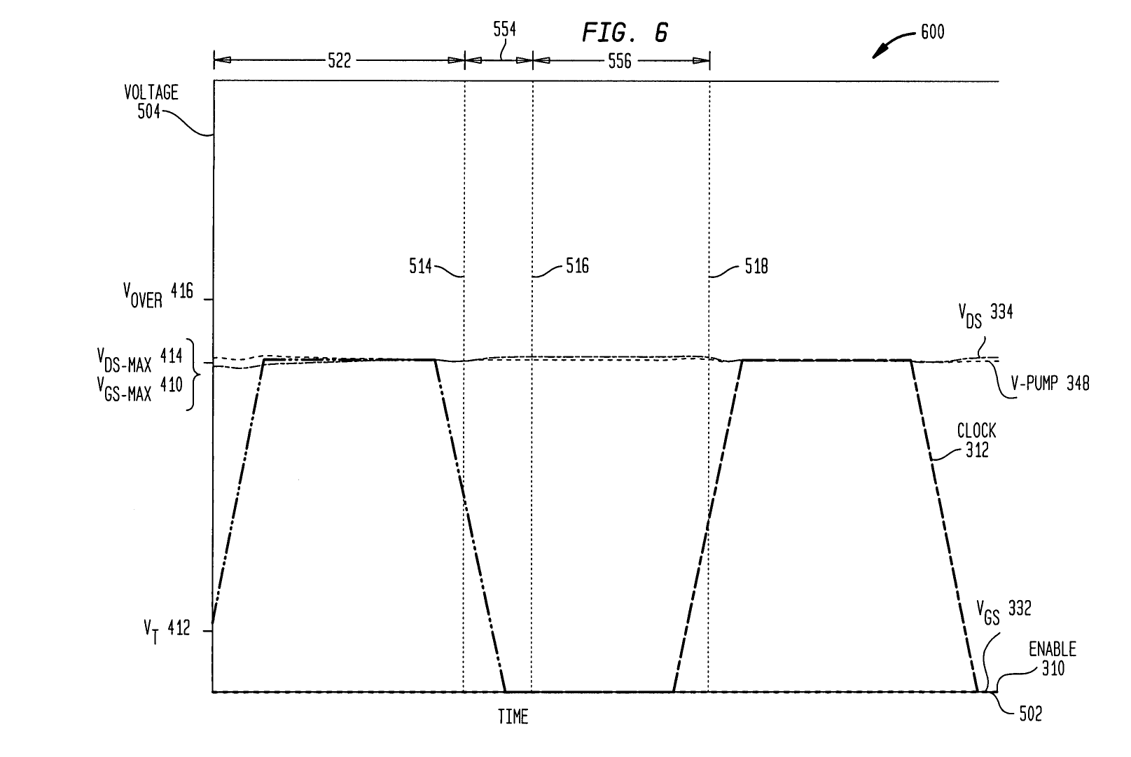

FIGS. 5 and 6 are voltage diagrams of selected signals and nodes of beacon circuit 300 when the beacon circuit is enabled (operational) and disabled (non-operational), respectively. The horizontal axis of each voltage diagram represents time while the vertical axis represents voltage. These exemplary voltage diagrams are representative of a silicon-on-insulator (SOI) fabrication process; however, as one of ordinary skill in the art would find apparent, the principles demonstrated herein also apply to bulk and other fabrication processes. FIG. 3 will now be described with reference to FIGS. 3-6.

Beacon circuit 300 includes a number of components, certain combinations of which operate together to perform particular functions. Such combinations of components are depicted in FIG. 3 with dashed boxes defining functional blocks of beacon circuit 300. In this exemplary embodiment, beacon circuit 300 includes a voltage pump circuit 302, turn-on ramp control circuit 304 and a sustain circuit 306. Circuits 302-306 of beacon circuit 300 interoperate to selectively drive MOSFET 336 to operate in safe operating region 406 and hot carrier event region 408.

Briefly, voltage pump circuit 302 provides a voltage to MOSFET 336 sufficient to increase the likelihood that the MOSFET experiences hot carrier events. Sustain circuit 306 controls the voltage applied to MOSFET 336 to extend the time that the device is likely to experience hot carrier events. If needed, turn-on ramp control circuit 304 limits the speed with which MOSFET 336 switches states, because rapid state changes might quickly drain the voltage provided by voltage pump 302.

Beacon circuit 300 is controlled by two external signals: an enable signal 310 and a clock signal 312. Enable signal 310 enables or disables beacon circuit 300. If enable signal 310 is true, beacon circuit 300 is operational and is controlled by clock signal 312 to drive MOSFET 336 alternately between safe operation region 406 and hot carrier event region 408. If enable signal 310 is false, beacon circuit 300 is disabled; that is, non-operational. As such, beacon circuit 300 does not produce light flashes when enable signal 310 is false. In the embodiment described below, periodic clock pulses from a clock input signal 312 sequentially activate portions of beacon circuit 300 to operate MOSFET 336 in hot carrier region 408 and produce a flash of light for each clock pulse. The time during which clock signal 312 is true is referred to herein as the “first half-cycle of clock signal 312,” and the time during which the clock signal is false is referred to as the “second half-cycle clock signal 312.”

Turning now to the individual components 302-306 of beacon circuit 300, sustain circuit 306, as noted, controls the voltage applied to MOSFET 336 to extend the time the MOSFET is likely to experience hot carrier events. In this exemplary embodiment, sustain circuit 306 comprises a capacitor 342 connected across the source and drain of MOSFET 336. A FET 340 is connected between V_{DD} 360 and V_{DS} 334, and is controlled by clock signal 312 inverted by inverter 338.

During the first half-cycle of clock signal 312, inverter 338 turns on FET 340. When on, FET 340 connects capacitor 342 to V_{DD} 360, thereby charging the capacitor to approximately V_{DD}. Referring to operational phase 552 of FIG. 5, during the first half-cycle of clock signal 312, V_{DS} 334 increases as capacitor 342 charges to nearly V_{DS-MAX} 414. As can be seen in graph 400 of FIG. 4, a value of V_{DS} 334 that is equal to or slightly less than V_{DS-MAX} 414 is insufficient to cause MOSFET 336 to operate in hot carrier event region 408. As will be described in detail below, V_{GS} 332 is momentarily above V_{T} 412, and drops below V_{T} during operational phase 552. Thus, referring to FIG. 4, MOSFET 336 does not enter hot carrier event region 408 during operational phase 552.

Voltage pump circuit 302, as noted, controls V_{DS} 334 to increase the likelihood that MOSFET 336 experiences hot carrier events. Voltage pump circuit 302 includes a capacitor 346 connected between V_{DS} 334 and the output of a NAND gate 344. NAND gate 344 receives enable signal 310 and clock signal 312 as inputs. NAND gate 344 discharges capacitor 346 during the first half-cycle of clock signal 312. Referring to FIG. 5, during the second half-cycle of clock signal 312, the output of NAND gate 344 provides a V_PUMP signal 348 with a fast-rising leading edge. This is shown to occur in operational phase 554 of FIG. 5. V_PUMP signal 348 causes charge stored in capacitor 346 to increase the voltage applied at V_{DS} 334. This causes V_{DS} 334 to rise sharply at the same time to a voltage greater than V_{OVER} 416, as shown in FIG. 5. Referring to FIG. 4, a value of V_{DS} 334 that exceeds V_{OVER} 416 defines a condition under which hot carrier events can occur in MOSFET 336. This condition is represented by, for example, an exemplary point 420, which is located in hot carrier event region 408 of FIG. 4.

Turn-on ramp control circuit 304, as noted, limits the speed with which MOSFET 336 switches states. In this illustrative embodiment, turn-on ramp control circuit 304 comprises a capacitor 356 connected across the gate and source of MOSFET 336. A series arrangement of FETs 354 and 358 is connected between V_{DD} 360 and V_{SS} 362, with capacitor 356 and the gate of MOSFET 336 connected to a node between FET 354 and FET 358. FET 354 is controlled by the output of a NOR gate 350. Inputs of NOR gate 350 are connected to clock signal 312 and, through an inverter 352, to enable signal 310. FET 358 is controlled by clock signal 312.

Specifically, turn-on ramp control circuit 304 controls the voltage at V_{GS} 332 to slowly turn on MOSFET 336. During the second half-cycle of clock signal 312, NOR gate 524 turns on pull-up FET 354. When turned on, FET 354 causes V_{GS} 332 to increase toward V_{DD} 360. At this time, capacitor 356 begins to charge as it, too, is connected to V_{DD} 360 through FET 354. The charging of capacitor 356 slows the rate at which V_{GS} 332 rises. This extends the time it takes MOSFET 336 to turn on, preventing a rapid discharge of capacitor 342.

This is shown in operational phases 554 and 556 of FIG. 5, wherein V_{GS} 332 ramps slowly upward during the second half-cycle of clock signal 312 as capacitor 356 is charged. Referring to FIG. 4, as V_{GS} 332 increases, it reaches V_{T} 412 and begins to turn on MOSFET 336, as illustrated by point 422 in FIG. 4. Referring to FIG. 5, vertical line 516 indicates where V_{GS} 332 reaches approximately V_{T} 412. As capacitor 356 charges, V_{GS} 332 approaches V_{DD} 360. V_{GS} 332 does not, however, reach V_{DD} 360, due to the internal resistance of FET 354. Thus, MOSFET 336 operates in hot carrier region 408 during operational phases 554 and 556.

During the second half-cycle of clock signal 312, FET 340 is turned off. Capacitor 342 of sustain circuit 306 discharges through MOSFET 336, initially sustaining V_{DS} 334 at a value greater than V_{OVER} 416. As illustrated in operational phase 556 of FIG. 5, V_{DS} 334 decreases as capacitor 342 discharges. During operational phase 556, V_{GS} 332 is greater than V_{T} 412. Thus, MOSFET 336 remains in hot carrier region 408 of FIG. 4 as V_{DS} 334 decreases to a voltage below V_{OVER} 416, and does not return to safe operation region 406 until V_{DS} 334 falls below V_{DS-MAX} 414. This condition is identified by vertical line 518 in FIG. 5, and is represented by point 424 in FIG. 4. Thus, MOSFET 336 begins to operate in hot carrier event region 408 during operational phase 554 and remains in hot carrier region 408 until the end of operational phase 556.

The maximum voltage by which V_{DS} 334 exceeds V_{DS-MAX} 414 is referred to as an “overshoot” voltage 522. Overshoot voltage 522 can be controlled by adjusting the ratio of the values of capacitors 346 and 342. In the simulation depicted in FIG. 5, the ratio of these two capacitors is approximately 1:1, but other ratios can be used. Capacitors 342 and 346 form a voltage divider circuit. Selecting values for capacitors 342 and 346 is well within the ability of an ordinary practitioner.

As noted, turn-on ramp control circuit 304 also includes FET 358, which is connected across capacitor 356 and is controlled by clock signal 312. During the first half-cycle of clock signal 312, FET 358 turns on, effectively shorting capacitor 356. This short discharges capacitor 356, thereby preparing the capacitor for a subsequent flash cycle. As can be seen in voltage plot 600, during the first half-cycle of the second clock pulse, V_{GS} 332 decreases to nearly zero as FET 358 discharges capacitor 356.

To summarize briefly, when beacon circuit 300 is operational (that is, enable signal 310 is true) the following occurs. During the first half of each cycle of clock signal 312, V_{DS} 334 and V_{GS} 332 are sufficiently low to cause MOSFET 336 to operate in safe operation region 406. This is shown in FIG. 5, in which V_{DS} 334 is less than V_{DS-MAX} 414 and V_{GS} 332 is less than V_{GS-MAX} 410 during operation phase 552. During the first half of each cycle of clock signal 312, inverter 338 and FET 340 of sustain circuit 306 charge capacitor 342 of circuit 306. During the second half of each cycle of clock signal 312, NAND gate 344 and capacitor 346 of voltage pump circuit 302 increase the voltage at V_{DS} 334 so that V_{DS} exceeds V_{OVER} 416, thereby operating MOSFET 336 in hot carrier region 408, near point 420 of FIG. 4. This is shown in FIG. 5, in which V_{DS} 334 rises steeply in operational phase 554 to a value above V_{OVER} 416. Also during the second half cycle of clock signal 312, inverter 352, NOR gate 350, FET 354 and capacitor 356 of turn-on ramp control circuit 304 control V_{GS} 332 to slowly turn on MOSFET 336. This is shown in FIG. 5, in which V_{GS} begins to rise slowly in operational phase 554 until it exceeds V_{T} 412 at line 516. MOSFET 336 begins to turn on when V_{GS} 332 reaches V_{T} 412, near point 422 of FIG. 4. As MOSFET 336 turns on, capacitor 342 begins to discharge through the MOSFET, and V_{DS} 334 begins to decrease. This is shown in FIG. 5, in which V_{DS} 334 decreases sharply in operational phase 556. However, because V_{GS} 332 exceeds V_{T} 412, MOSFET 336 remains in hot carrier event region 408 until V_{DS} 334 falls below V_{DS-MAX} 414, near point 424. This is shown in FIG. 5, in which V_{DS} 334 drops below V_{DS-MAX} 414 at line 518. Thus, MOSFET 336 can produce a flash of light during each second half-cycle of clock signal 312. Then, during the first half of the next cycle of clock signal 312, FET 358 discharges capacitor 356, preparing the capacitor for a subsequent flash cycle. Enable signal 310 can be set to true for a just one clock cycle to produce one flash, or it can be held true for more than one clock cycle to produce a series of flashes.

When beacon circuit 300 is not operational (that is, enable signal 310 is false) V_{DS} 334 is maintained at V_{DS-MAX} 414 and V_{GS} 332 is maintained at approximately zero volts. This condition causes MOSFET 336 to be off and, therefore, operate in safe operation region 406. This operational state is reflected in timing diagram 600 illustrated in FIG. 6. As can be seen in timing diagram 600, V_{GS} 332 remains zero and V_{DS} 334 does not exceed V_{DS-MAX} 414. Thus, the simulation shows that the voltages applied to MOSFET 336 are not likely to cause hot carrier events when enable signal 310 is false.

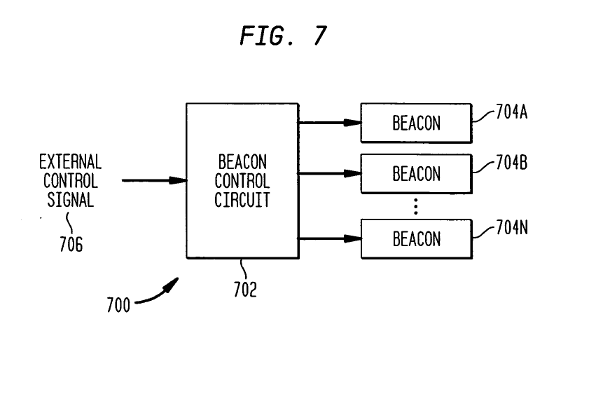

As noted, some embodiments of the present invention deploy several beacons on an IC die. The beacons are preferably selectively enabled near locations of interest when the IC is tested. FIG. 7 is a simplified block diagram of a beacon system 700, according to one embodiment of the present invention. In this embodiment, a beacon control circuit 702 controls a plurality of beacons 704A-N (collectively 704). Beacon control circuit 702 and beacons 704 reside on a common IC. Beacon control circuit 702 selectively enables or disables beacons 704 individually or in groups.

Beacon control circuit 702 is controlled by an external control signal 706 from, for example, another circuit, such as a microprocessor, on the IC. Alternatively, external control signal 706 can be supplied by test equipment, or in response to user inputs. External control signal 706 can cause beacon control circuit 702 to enable selected beacons 704 that are near circuits or other locations of interest on the IC, so the user or automated test equipment can position a PICA detector or microscope until flashes from the selected beacons are visible in the PICA image window. Alternatively, selected beacons 704 can be used to register the PICA image window with a photomicrograph or CAD/M diagram.

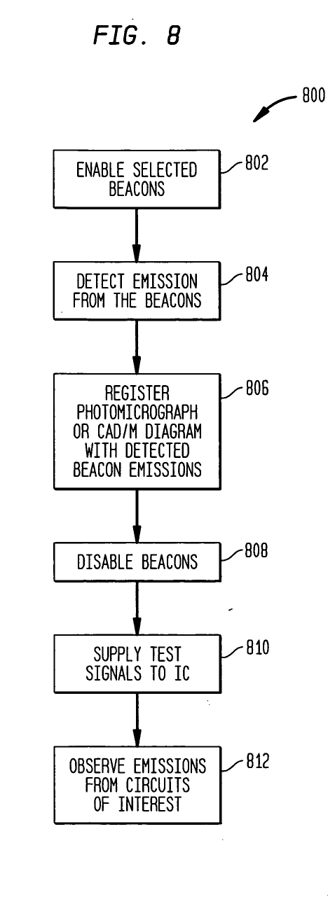

FIG. 8 is a flowchart 800 that shows how an embodiment of the invention facilitates interpreting observed radiation emissions from an IC. At block 802, selected beacons are enabled. The set of selected beacons depends on the locations of interest in the IC. Typically, at least one beacon close to the locations of interest is selected. At block 804, emissions from some or all of the enabled beacons are detected. At block 806, a photomicrograph or CAD/M diagram is registered with the detected beacon emissions. The beacons are then disabled at block 808. Test signals are applied to the IC at block 810 and, at block 812, emissions from the IC are observed. Because the photomicrograph or CAD/M diagram was registered with the emissions from the selected beacons, emissions observed at 812 can be interpreted in the context of the photomicrograph or CAD/M diagram.

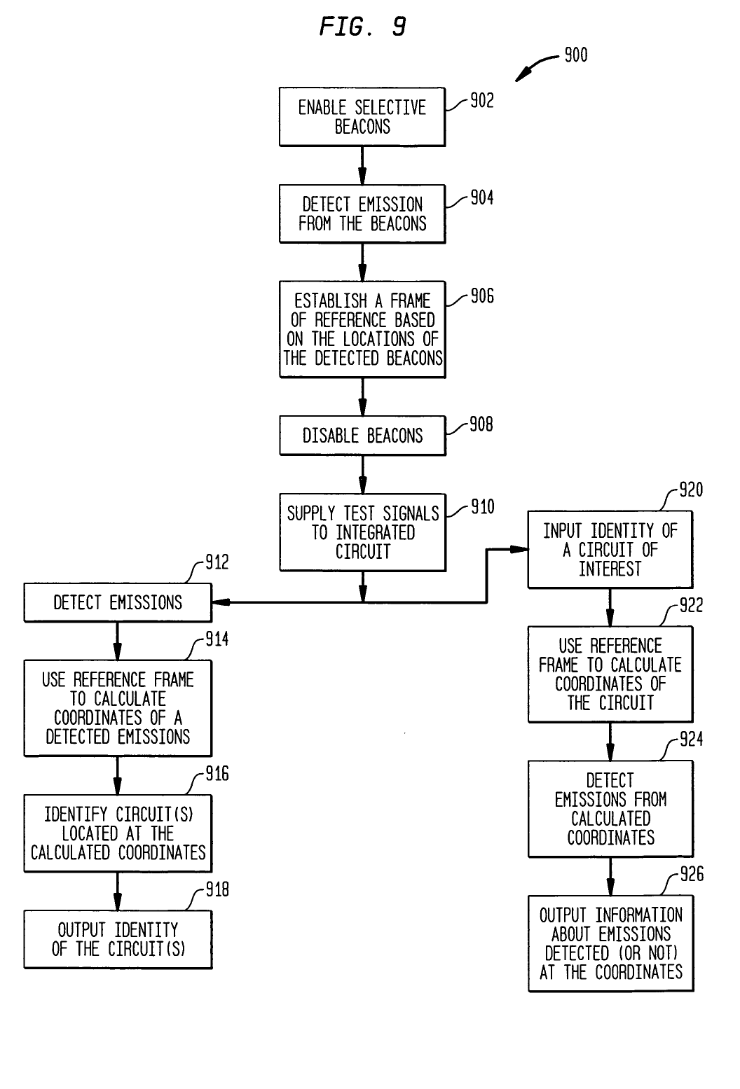

FIG. 9 is a flowchart 900 that shows how another embodiment of the invention establishes a frame of reference for an IC. This reference frame can be used to identify circuits whose flashes are detected. In addition, this reference frame can be used to calculate coordinates of a location of interest on an IC, so a user can, for example, know where to look for flashes emitted by a circuit at that location on the IC. At block 902, selected beacons are enabled. As described with reference to FIG. 8, the set of selected beacons can depend on locations of interest in the IC.

At block 904, emissions from some or all of the enabled beacons are detected. At block 906, a reference frame is established based on the locations of the detected beacon emissions. For example, the location of one beacon can be used to establish an origin, i.e. (0,0), for the reference frame. Optionally, the location of a second beacon can be used with the location of the origin to establish an axis, such as the x-axis, of the reference frame. At 908, the beacons are disabled. At block 910, test signals are applied to the IC.

If emissions from circuits under test are detected, such as at block 912, at block 914 the reference frame can be used to calculate coordinates of the detected emissions. At block 916, these coordinates can be used to identify circuits that radiated the emissions, such as by consulting a CAD/M database that contains information about the positions of circuits on the IC. Optionally, at block 918, the identities of the circuits can be output to a user. For example, these identities can include descriptions of the circuits, their expected behaviors, input and/or output signals or indexes into the CAD/M database.

On the other hand, if a user wishes to observe signals from a particular circuit of interest, at block 920 an identity of the circuit is input. At block 922, the reference frame is used to calculate coordinates of the circuit of interest. At 924, emissions (if any) from the calculated coordinates are detected. At block 926, information about the detected emissions, or lack thereof, is output. For example, this information can include a frequency or waveform of a detected signal or a motion picture of the detected emissions.

Although locations of interest are likely to be locations of circuits on a die of an IC, beacons, according to the present invention, can be used to locate non-electrical features in an IC. For example, mechanical locations of interest can be identified by their positions, relative to the position of one or more beacons, as long as a relationship can be established, even after manufacture of the IC, between the locations of interest and one or more beacons.

Although the beacons of the present invention have been described with reference to identify locations on an IC, they can be used for other purposes. For example, the detected brilliance of a beacon can be used as a standard, against which emissions from other circuits are compared. In such a scenario, a beacon is operated with a known duty cycle, and its detected brilliance is measured. Then, a circuit under test is operated and emissions from the circuit are compared to the beacon's measured brilliance. The relative brilliance of emissions from the circuit under test can tell a user the duty cycle of the circuit under test. For example, the user can ascertain what fraction of the time the circuit under test is in a particular logic state or a rate at which the circuit under test switches its logic state.

Furthermore, a beacon can be used as a sacrificial component in an IC to estimate the life expectancy of other circuits in the IC. By operating the beacon continuously until it fails, and measuring the life of the beacon, a user can estimate the number of state changes other circuits in the IC can undergo before they fail.

The beacons of the present invention are preferably implemented in hardware as IC circuits or components that are likely to experience hot carrier events and, therefore, emitted light. Alternatively, other types of circuits or components that emit detectable radiation can be used. This radiation is preferably, but not necessarily, visible light. For example, a light emitting diode (LED) can be used as a beacon. This LED could emit infrared (IR) radiation or visible light. Furthermore, other semiconductors, such as those fabricated of gallium arsenide (GaAs), possibly doped with phosphorus, oxygen, nitrogen and/or zinc, can be used to emit light.

Light emission from semiconductors can be enhanced by several special mechanisms. For example, one of the best conditions for light emission occurs during reverse bias. During impact ionization, more carriers combine to emit photons. This condition is sometimes referred to as “avalanche luminescence.” Tunneling through dielectric films also produces light in an effect called “dielectric luminescence,” which is particularly useful in producing light from capacitor anomalies. Large currents in diodes or FETs emit light during minority carrier recombination, commonly referred to as “saturated n-type emission.” Quantum dots can also be used as beacons.

1. A position reference beacon for an integrated circuit, comprising:
a device capable of emitting radiation and disposed at a reference location on the integrated circuit, wherein the device is capable of being controlled independent of integrated circuit operations.

2. The beacon of claim 1, further comprising:
a control circuit connected to the device and configured to selectively enable the device to emit radiation.

3. The beacon of claim 2, wherein the control circuit is responsive to a signal external to the integrated circuit.

4. The beacon of claim 1, wherein the device is a field-effect transistor (FET) that emits photons when the FET experiences a hot carrier event.

5. The beacon of claim 1, wherein the device is a light-emitting diode.

6. The beacon of claim 11, wherein the device is a diode.

7. The beacon of claim 11, wherein the device is a quantum dot.

8. A method for identifying a location of interest on an integrated circuit, comprising:
providing at least one beacon capable of emitting radiation, positioned at a reference location on the integrated circuit and capable of being controlled independent of the normal operation of the integrated circuit.

9. The method of claim 8, further comprising:
causing one or more of the at least one beacon to emit radiation.

10. The method of claim 9, wherein the causing one or more of the at least one beacon to emit radiation comprises:
for each of the one or more of the at least one beacon, applying voltages to a device to increase a likelihood that the device experiences a hot carrier effect.

11. The method of claim 8, further comprising:
detecting radiation emitted by at least one of the one or more beacons.

12. The method of claim 8, further comprising:
for at least one beacon that produces detected radiation, identifying the reference location that corresponds to that beacon.

13. The method of claim 12, further comprising:
using at least one identified reference location to identify the location of interest on the integrated circuit.

14. The method of claim 13, wherein the using at least one identified reference location comprises:
using information about a position of the location of interest, relative to the at least one identified reference location, to identify the location of interest on the integrated circuit.

15. The method of claim 13, wherein the using at least one identified reference location to identify the location of interest comprises:
providing coordinates of the location of interest.

16. The method of claim 13, wherein the using at least one identified reference location to identify the location of interest comprises:
providing information about a circuit located at the location of interest.

17. The method of claim 8, further comprising:
using the reference location that corresponds to at least one beacon to register an image window of an integrated circuit diagnostic tool.

18. The method of claim 17, wherein the integrated circuit diagnostic tool is a light emission microscopy system.

19. A method for identifying a location on an integrated circuit, comprising:
causing at least one beacon on the integrated circuit to emit radiation; and
registering information about locations of interest on the integrated circuit with a location of at least one beacon.

20. The method of claim 19, further comprising:
detecting radiation emitted by at least one of the at least one beacon.

21. The method of claim 19, further comprising:
detecting radiation emitted by circuits of interest in the integrated circuit.

22. The method of claim 19, further comprising:
causing the one or more beacons to cease emitting radiation.

23. A method for identifying a location on an integrated circuit, comprising:
causing one or more independently-controllable beacons on the integrated circuit to emit radiation; and
establishing a frame of reference based on a location the at least one beacon from which radiation is detected.

24. The method of claim 23, further comprising:
detecting radiation emitted by at least one of the beacons.

25. The method of claim 23, further comprising:
detecting radiation emitted by a circuit on the integrated circuit.

26. The method of claim 25, further comprising:
using the frame of reference to identify a location on the integrated circuit that is a source of the radiation emitted by the circuit.

27. The method of claim 26, further comprising:
using the identified location on the integrated circuit to identify the circuit that emitted the detected radiation.

28. The method of claim 23, further comprising:
causing the one or more beacons to cease emitting radiation.

29. The method of claim 23, further comprising:
using the frame of reference to calculate a position on the integrated circuit of a location of interest; and
detecting radiation emitted from the calculated position on the integrated circuit.

30. An integrated circuit, comprising:
at least one beacon circuit, each having at least one component capable of emitting radiation and being disabled without impacting normal operation of the integrated circuit; and
functional circuitry located on the integrated circuit at a predetermined location relative to the at least one beacon circuit.

31. The integrated circuit of claim 30, further comprising:
a control circuit, connected to the at least one beacon circuit, configured to selectively enable at least one beacon circuit.

32. The integrated circuit of claim 30, wherein, when the integrated circuit operates in a test mode, a control circuit enables at least one beacon circuit and, when the integrated circuit operates in another mode, the control circuit disables the at least one beacon circuit.

33. A position reference beacon for an integrated circuit, comprising:
means for emitting radiation upon occurrence of a hot carrier event, positioned at a corresponding reference location on the integrated circuit and capable of being disabled without impacting normal operation of the integrated circuit;
means, connected to the means for emitting radiation, for providing a voltage to the means for emitting radiation likely to cause a hot carrier event in the means for emitting radiation; and
means, connected to the means for emitting radiation, for extending duration of the hot carrier event.

34. The beacon of claim 33, further comprising:
means, connected to the means for emitting radiation, for slowing switching time of the means for emitting radiation.
